(19) United States
(12) Patent Application Publication
(10) Pub. No.: US 2025/0183730 A1
(43) Pub. Date: Jun. 5, 2025

(54) LOAD DISCONNECT SWITCH SYSTEM FOR A WIRELESS POWERED APPLIANCE

(71) Applicant: Midea Group Co., Ltd., Beijiao (CN)

(72) Inventors: John Kenneth Hooker, Louisville, KY (US); Hieu Manh Vu, Louisville, KY (US)

(73) Assignee: Midea Group Co., Ltd., Beijiao (CN)

(21) Appl. No.: 18/528,497

(22) Filed: Dec. 4, 2023

(51) Int. Cl. H02J 50/80; H02J 7/00; H02J 7/34; H02J 50/12

(52) U.S. Cl. CPC H02J 50/80; H02J 7/0068; H02J 7/345; H02J 50/12; H02J 2310/14; H02J 2310/52; H02J 2310/58

(57) ABSTRACT

A power circuit for resonant power transmission to an appliance that receives power through an electromagnetic transmission from a power transmitter. The power circuit uses a near field communication (NFC) to detect wireless communication to the appliance. A relay that selectively decouples a load when the appliance and the power transmitter are not in a connected state. A latching circuit is used to trigger the relay in a connected state. The relay is held close by a storage element that is powered from by an NFC circuit.

### BACKGROUND

This disclosure relates in general to wireless powered appliances and, not by way of limitation, to provisioning power transmission to an appliance, among other things.

Wireless charging is a well-known phenomenon of charging phones without physical electrical contact. This technology operates on the principles of electromagnetic induction, a process by which electrical current is generated in a conductor by varying the magnetic field around it. The charger transfers energy through inductive coupling to the coil of the wireless phone.

The emitter coil, often housed within a charging pad or station, generates a magnetic field when an electric current passes through it. This magnetic field, in turn, induces an electric current in the nearby receiver coil embedded in the portable appliance. This induced current is then converted back into electrical power, effectively charging the battery of the appliance. The entire process occurs without any direct electrical conduction between the charging source and the device, providing a convenient way to wirelessly power a device.

Wireless devices are not designed to be powered by conventional induction cooktops. Attempting such an operation is hazardous for the device and any occupants. While the typical conventional induction cooktop may use operational frequencies that overlap with those accepted by the wireless device, the cooktop does not provide any safety or control of the power transfer.

### SUMMARY

A power circuit for resonant power transmission to an appliance that receives power through an electromagnetic transmission from a power transmitter. The power circuit uses a near field communication (NFC) to detect wireless communication to the appliance. A relay that selectively decouples a load when the appliance and the power transmitter are not in a connected state. A latching circuit is used to trigger the relay in a connected state. The relay is held close by a storage element that is powered from by an NFC circuit.

In an embodiment, a power circuit with near field communication (NFC) using a resonant power transmission to power an appliance. The power circuit contains a relay to selectively couples or decouples a load for the appliance. An NFC circuit comprising a data communication circuit for receiving data. A power supply harvesting the resonant power transmission to the appliance. A latching circuit that controls the relay to couple the power supply to the load when the data communication circuit detects wireless communication to the appliance. The latching circuit decouples the power supply to the load if the appliance is disconnected. The decoupling is delayed as a function of a capacitor and a plurality of resistors, and the capacitor is energized with power from the NFC circuit.

In an embodiment, a method for power circuit with near field communication (NFC) using a resonant power transmission to power an appliance. The power circuit is configured for decoupling a load for the appliance by a relay selectively. The power circuit receives data by a data communication circuit in NFC circuit, detecting presence of a power transmitter. The power circuit in response to detecting a power transmitter, controlling the rely by a latching circuit and hold the relay close during the resonant power transmission. The decoupling is delayed as a function of a storage element and a bleeder element. The power circuit provides power by a storage element to the relay, wherein the power is harvested from a resonant power transmission to the appliance. The storage element is energized with power from the NFC circuit.

In an embodiment, a power circuit with near field communication (NFC) using a resonant power transmission to power an appliance. The power circuit contains a relay to selectively couples or decouples a load for the appliance. An NFC circuit comprising a data communication circuit for receiving data. A power supply harvesting the resonant power transmission to the appliance. A latching circuit that controls the relay to couple the power supply to the load when the data communication circuit detects wireless communication to the appliance. The latching circuit decouples the power supply to the load if the appliance is disconnected. The decoupling is delayed as a function of a storage element and a bleeder element, and the storage element is energized with power from the NFC circuit.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of a system 100 in a power circuit for a resonant power transmission;

FIG. 2 illustrates a circuit diagram of an embodiment of a relay circuit of the power transmission between a power receiver and a power transmitter;

FIG. 3 illustrates a circuit diagram of an embodiment of the relay circuit connecting ta load to a resonant power circuit;

FIG. 4 illustrates a circuit diagram of an embodiment of a power supply with a low voltage;

FIG. 5 illustrates a circuit diagram of an embodiment of a latching circuit implemented with a semiconductor-controlled rectifier (SCR) switch;

FIG. 6 illustrates a circuit diagram of an embodiment of the latching circuit implemented with complementary metal-oxide semiconductor (CMOS) gates and a small signal transistor;

FIG. 7 illustrates a circuit diagram of an embodiment of a near field communication (NFC) circuit;

FIG. 8 illustrates a state diagram of an embodiment of the relay circuit in the power circuit for the resonant power transmission in a control sequence;

FIG. 9 illustrates a flow diagram of an embodiment of a system in the power circuit for resonant power transmission;

FIG. 10 illustrates a diagram of an embodiment of the resonant power transmission from the power transmitter to the appliance.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

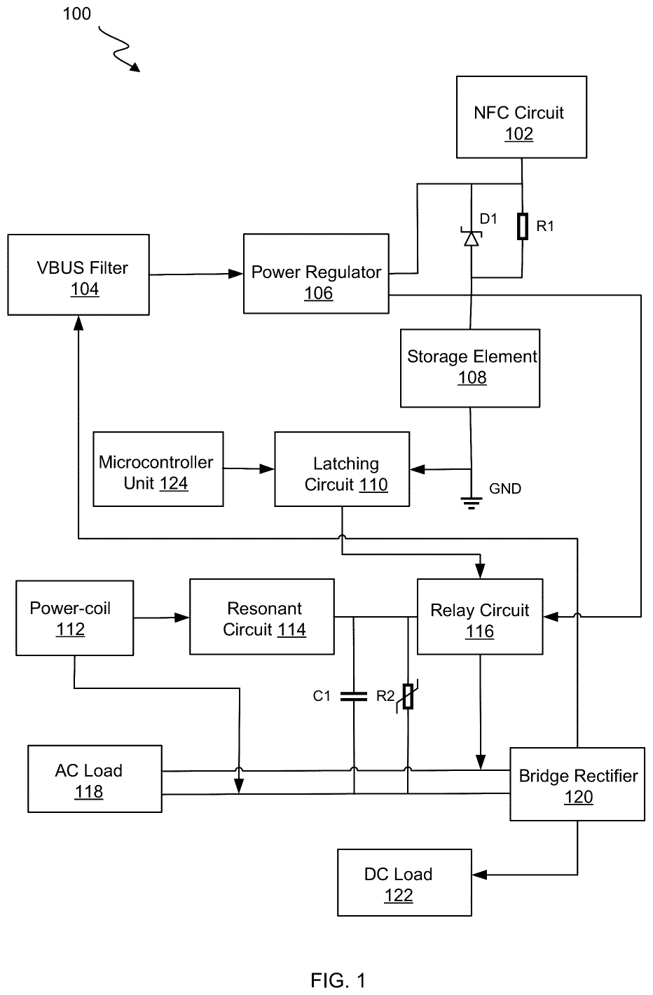

Referring to FIG. 1, a block diagram of an embodiment of a system 100 in a power circuit for resonant power transmission. The system 100 contains a near field communication (NFC) circuit 102, a microcontroller unit 124, a VBUS filter 104, a power regulator 106, a storage element 108, and a latching circuit 110. In addition, the system 100 further contains a power-coil 112, a resonant circuit 114, a relay circuit 116, an alternating current (AC) load 118, a bridge rectifier 120, a direct current (DC) load 122, a diode D1, a resistor R1, a capacitor C1, and a variable resistor R2. The NFC circuit 102 is responsible for harvesting power from the NFC communication between a power receiver and a power transmitter. A communication circuit used in NFC communication is not shown as it is the same technology used in the industry is not a focus of this disclosure. The VBUS filter 104 stabilizes a direct current (DC) voltage coming from the bridge rectifier 120. The stable DC voltage is provided to the power regulator 106 that steps down the voltage according to the requirement. The storage element 108 provides power to the relay circuit 116 during transition of states. The latching circuit 110 activates the relay circuit 116 that in turn connects the load with power supply, when instructed by the microcontroller unit 124.

The power-coil 112 paired with the resonant circuit 114 is responsible for absorbing power through an electromagnetic coupling. An inductive power supply is converted into a DC supply by the bridge rectifier 120. The DC supply is provided to the DC load 122 in the appliance motor, for example a DC motor in an air fryer appliance. The relay circuit 116 is placed between a connection of a load (AC and DC) and the inductive power supply coming from the resonant circuit 114. This relay circuit 116 is operated by the latching circuit 110 that provides the power stored in the storage element 108 to be delivered to the relay circuit 116 and connects the load to the inductive power supply.

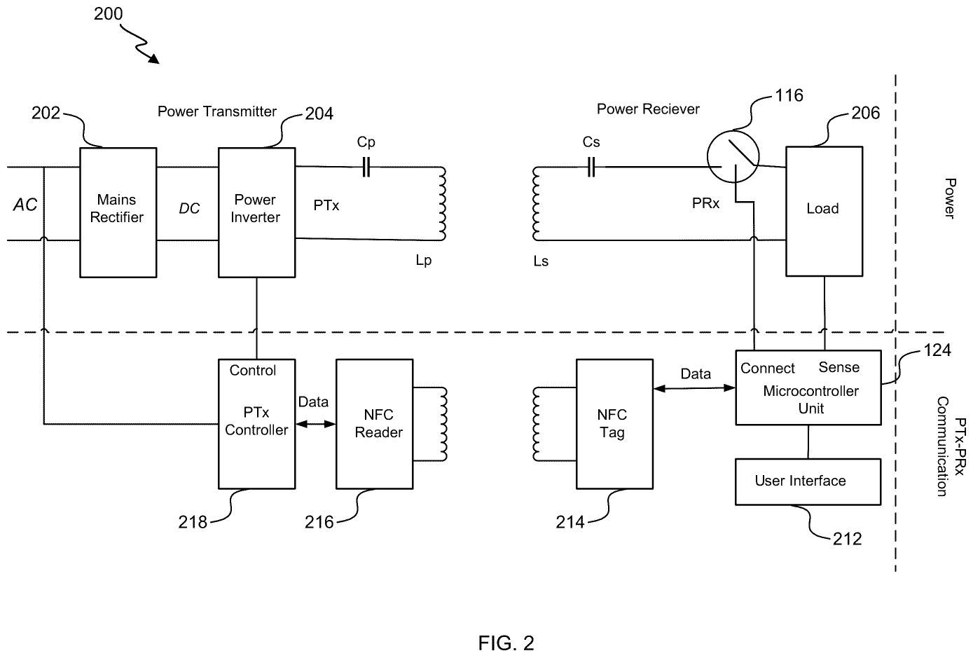

Referring to FIG. 2, a block diagram of an embodiment of a relay circuit 116 in a system of the resonant power transmission between the power receiver and the power transmitter. The resonant power transmission system contains a mains rectifier 202, a power inverter 204, a PTx controller 218, an NFC reader 216, a primary capacitance Cp and a primary coil Lp in the power transmitter. The power receiver includes a load 206, a microcontroller unit 124, a user interface 212, an NFC tag 214, a switch in a relay circuit 116, a secondary capacitance Cs and a secondary coil Ls. The mains rectifier 202 converts an AC supply (AC power) to a DC supply (DC power). The power inverter 204 converts the DC power to high frequency AC power. The microcontroller unit 124 controls the amount and direction of the power transmission based on a data from the NFC reader 216. The NFC reader 216 and NFC tag 214 are part of communication circuit of the power transmitter and the power receiver, respectively. The NFC reader 216 reads the data from the NFC tag 214 of the power receiver, such as its identity, power level, load impedance, and/other settings, parameters, and configuration. If one-to-one communication between the power transmitter and the power receiver is established the PTx controller 218 will signal the power transmitter to transfer power. For example, Ki™ standard developed by a wireless power consortium entails authorized NFC communication before transferring the power to a high-power appliance.

In this implementation the resonant power transmission which is a method of transferring electrical energy without any direct electrical contact occurs when the power receiver and the power transmitter are tuned at a resonant frequency. The power transmitter generates a high frequency AC power to the primary coil Lp with a capacitor Cp in series. An electromagnetic flux is generated around the primary coil Lp, which induces a voltage in the secondary coil Ls of the power receiver. The microcontroller unit 124 will close the relay circuit 116 and allow the power to transfer to the load 206 of the power receiver. The microcontroller unit 124 also controls the user interface 212 of the appliance. The user interface 212 contains buttons, LEDs, LCDs, etc. to give output or take input from a user.

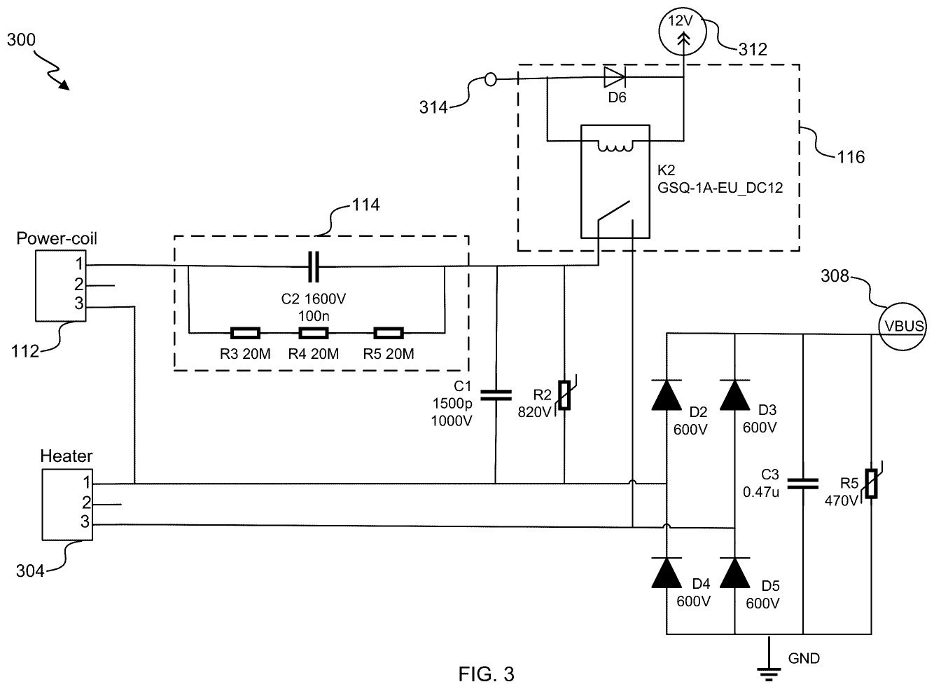

Referring to FIG. 3, a circuit diagram of an embodiment of the relay circuit 116 connecting the load 206 to the resonant circuit 114. The circuit diagram includes a heater 304, a VBUS 308, a terminal 312, the power-coil 112, the resonant circuit 114, the relay circuit 116, resistors R2-5, capacitors C1-3, diodes D2-6, and a relay K2. The power-coil 112 is responsible for supplying induction power from the power transmitter connected to a power resonant circuit. The power-coil 112 combined with resonant circuit 114 absorbs the power better from the electromagnetic flux. The capacitor C1 bypass the open load at the NFC frequency (13.56 MHz) so the NFC circuit 102 is not detuned when the load 206 is not connected. R2 is an optional component for protection against overvoltage transients which could occur in mistimed load transitions but ultimately may not be required in a well-behaved system. The diode D6 combined with the relay K2 forms a relay circuit 116 that connects the load 206 to the power supply when a one-to-one communication between the power receiver and power transmitter has been established. The D6 is a free-wheeling diode that prevents a voltage spike on the relay K2 driver when the relay K2 is turned off. The relay K2 is placed between the connection of the AC supply and the load 206. In the present implementation, GSQ-1A-EU_DC12 is the relay part number used in the relay circuit 116. Any relay that fulfills the demand of coil power, voltage and current can be used in place of this chip. The relay K2 contains an electromechanical coil and a switch that closes when the coil is energized. The terminal 316 of 12 voltage (V) provides the connection from the latching circuit 110 that controls the switching of the relay K2. The bridge rectifier 120 is implemented with D2-5, C4 and R5 to convert the AC supply into the DC supply. The heater 304 is an example of the AC load 118, when the relay K2 closes the heater 304 is connected to the power supply. The heater 304 is an example of AC load 118. The terminal 312 connect the storage element 108 to the relay circuit 116 and provides the 12V power for relay circuit 116 for functioning during transitions. The VBUS 308 is connected to the DC load 122 in addition to the power supply that converts a supply voltage to a low voltage.

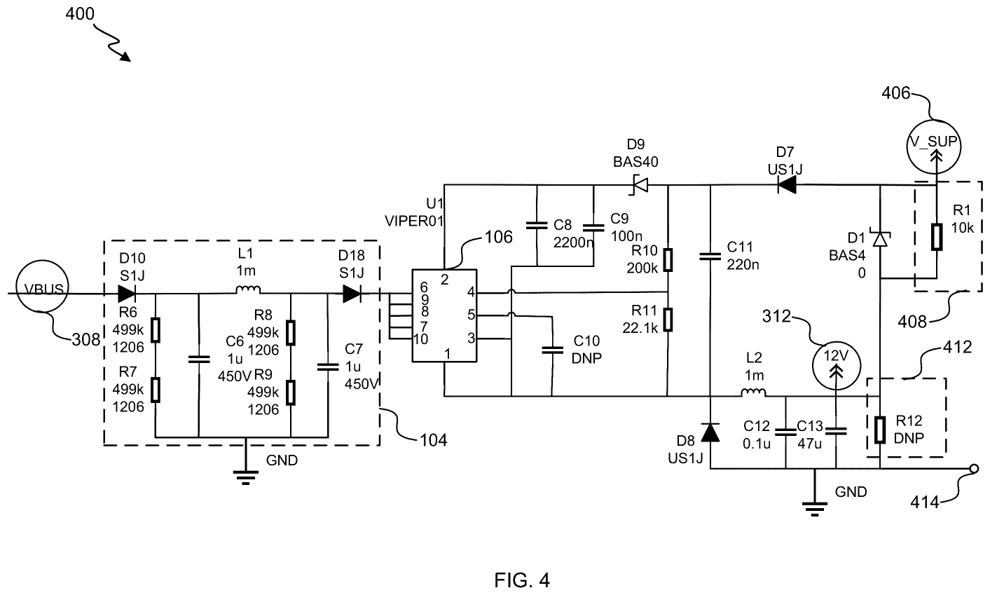

Referring to FIG. 4, a circuit diagram of an embodiment of a power supply with a low voltage. The embodiment includes a V_SUP 406, a VBUS 308, resistors R6-12 and R1, capacitors C6-13, diodes D7-10, D1 and D18, inductors L1-2, the VBUS filter104 and the power regulator 106. The VBUS 308 provides a DC voltage to the power supply. In this implementation, we used a buck regulator as the power regulator 106. The diodes D10 and D18, inductor L1, and the capacitors C6 and C7 form the VBUS filter 104 that stabilize the VBUS 308 for the buck regulator. The resistors R6-9 are placed parallel at the input to discharge the capacitors C6 and C7 when the appliance transitions from a powered state to a connected state. The values of C6-7 and R6-9 are selected such that the power supply of 12V turns off before C13 starts charging. The power regulator 106 that is a buck regulator in this embodiment implemented by a VIPERO1 chip, converts the DC power supply to a lower voltage i.e., 12V. The capacitor C13, used as a storage element 108, trickles the charge from the power harvested from the NFC circuit 102 from terminal V_SUP 406 through the bleeder resister R1. The time constant of R1 and C13 is such that the C13 is charged to close the relay K2 within 2 seconds after the power receiver is placed on the power transmitter. The resistor R12 is removed from this embodiment as it interferes with the charging of C13.

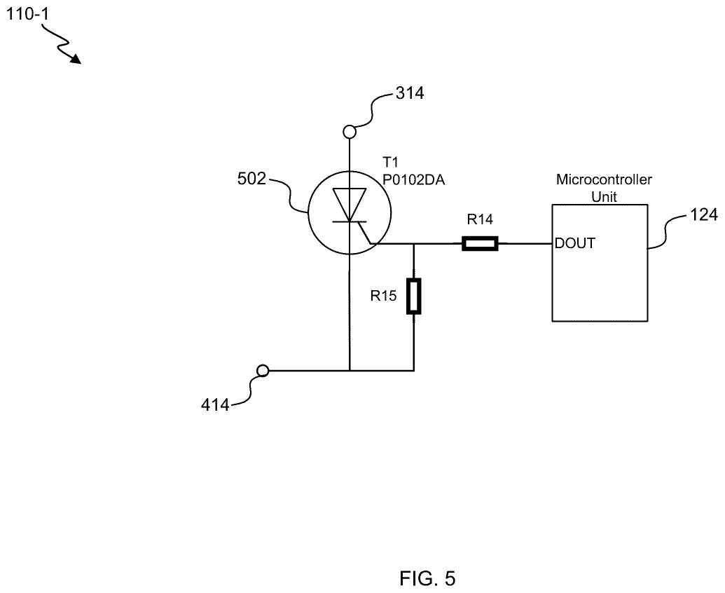

Referring to FIG. 5, a circuit diagram of an embodiment of a latching circuit 110 implemented with a semiconductor-controlled rectifier (SCR) switch 502. The embodiment of the latching circuit 110-1 contains an SCR 502, the microcontroller unit 124 and resistors R14-15. The SCR 502 implemented by P0102DA has three terminals: a cathode, an anode and a gate. The anode is connected with a relay switch through the terminal 314 and the cathode is connected to the ground of the power supply from the terminal 414. The gate is connected to a microcontroller unit 124 through resistors R14 and R15. The resistors R14-15 serve the purpose of triggering the circuit. The microcontroller unit 124 sends out a positive DOUT signal to enable the connection between the anode and the cathode of SCR 502. The DOUT signal is an impulse signal that isn't continuously provided to the gate of SCR 502 to hold the connection between the anode and the cathode. In case of malfunction of the microcontroller unit 124 or power fluctuations, the SCR 502 will not affect its function and will continue to provide the connection of the power supply to the relay switch.

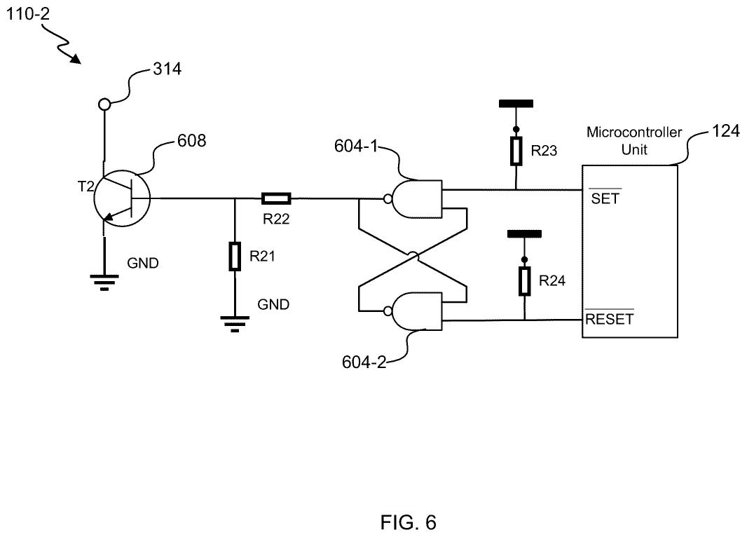

Referring to FIG. 6, a circuit diagram of an embodiment of the latching circuit 110-2 implemented with complementary metal-oxide semiconductor (CMOS) gates and a small signal transistor 608. The embodiment of the latching circuit 110-2 includes a small signal transistor 608, a microcontroller unit 124, NAND gates 604 1-2 and resistors R 21-24. The NAND gates 6041-2 form a set-reset (SR) latch that is controlled by the microcontroller unit (MCU) 124. Pull-up resistors R23 and R24 prevent maloperation of the latch when the microcontroller unit 124 is in the reset state. The microcontroller unit 124 sends out active low signals to SR latch that is further connected to the gate terminal of the small signal transistor 608 through the resistors R21 and R22. Here, the microcontroller unit 124 has two signals to turn the switch T2 on and off. The S̅E̅T̅ signal is for turning the relay circuit 116 on and the R̅E̅S̅E̅T̅ signal is to turn the relay circuit 116 off. Since the relay circuit 116 can be turned off by force in this embodiment, the bleeder resistors R6-9 can be reduced in size or removed because there is no requirement to turn off the power supply of 12V as quickly as in the 110-1 embodiment, which also eliminates the use for extra diode D6.

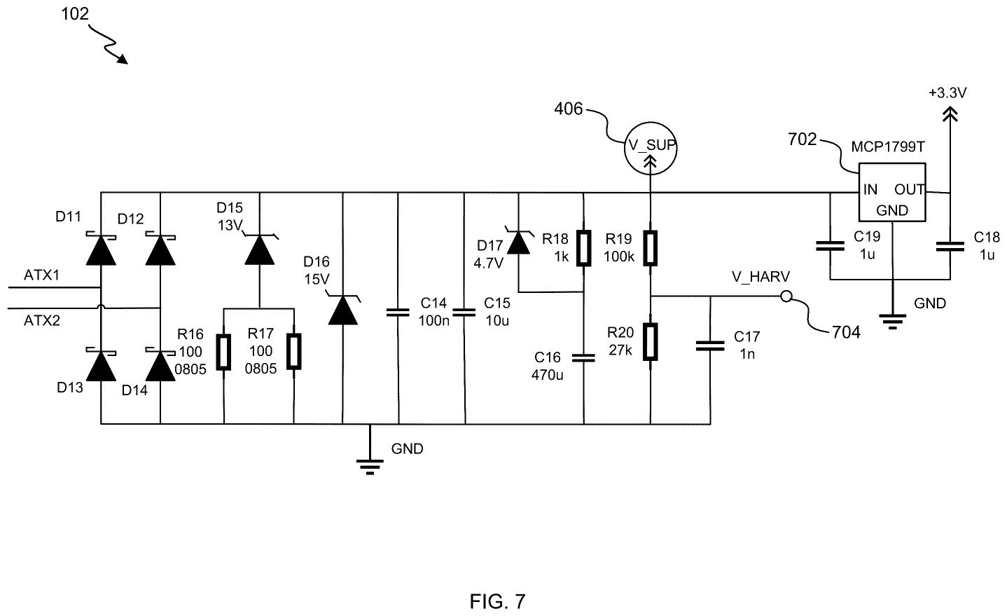

Referring to FIG. 7, a circuit diagram of an embodiment of a near field communication (NFC) circuit 102. This NFC circuit 102 is responsible for power harvesting from the power transmitter. The NFC circuit 102 contains a voltage regulator 702, a V_HARV 704, a V_SUP 406, diodes D11-17, resistors R16-20, and capacitors C14-19. Schottky diodes D11-14 are connected in rectifying bridge configuration. The signal ATX1 and ATX2, coming from an NFC antenna is converted into DC at the input of voltage regulator 702. The resistors R16 and R17 provide for an additional 50 Ohm load when V_SUP exceeds the breakdown voltage of Zener diode D15 (13V in our embodiment). In some embodiments Zener diode D16 may be considered optional if the NFC reader 216 can never supply sufficient power for V_SUP to reach its breakdown voltage (15V in this embodiment). The capacitor C16 and the resistor R18 form a low pass filter. R18 limits the current into large capacitor C16 until the C14 and C15 are sufficiently charged to allow operation of voltage regulator 702, at which point Zener diode D17 allows current to flow more rapidly into C16. This Zener diode and R18 of 1 k provide a fast boot-up. The storage capacitors C14, C15, and C16 smooth out the voltage fluctuations in the signal and provide stable power supply. The V-SUP voltage regulator 702 provides a constant voltage to the microcontroller unit 124 and other components in the circuit. The voltage regulator 702 implemented with MCP1799T chip, is a high voltage low drop out regulator to provide a consistent voltage at V_SUP 406. It also regulates the output voltage. The capacitor C16 provides bulk storage to keep the microcontroller powered during transition changes between Connected and Power modes. C18-19 are recommended for stability of the voltage regulator 702. The resistors R19 and R20 form a voltage divider circuit that provides a portion of the V_SUP 406 signal at 704 so the microcontroller can regulate the V-SUP voltage by sending requests to the transmitter to increase or decrease the field strength of the NFC transmitter. The V_HARV 704 is an analog signal to regulate V_SUP 406.

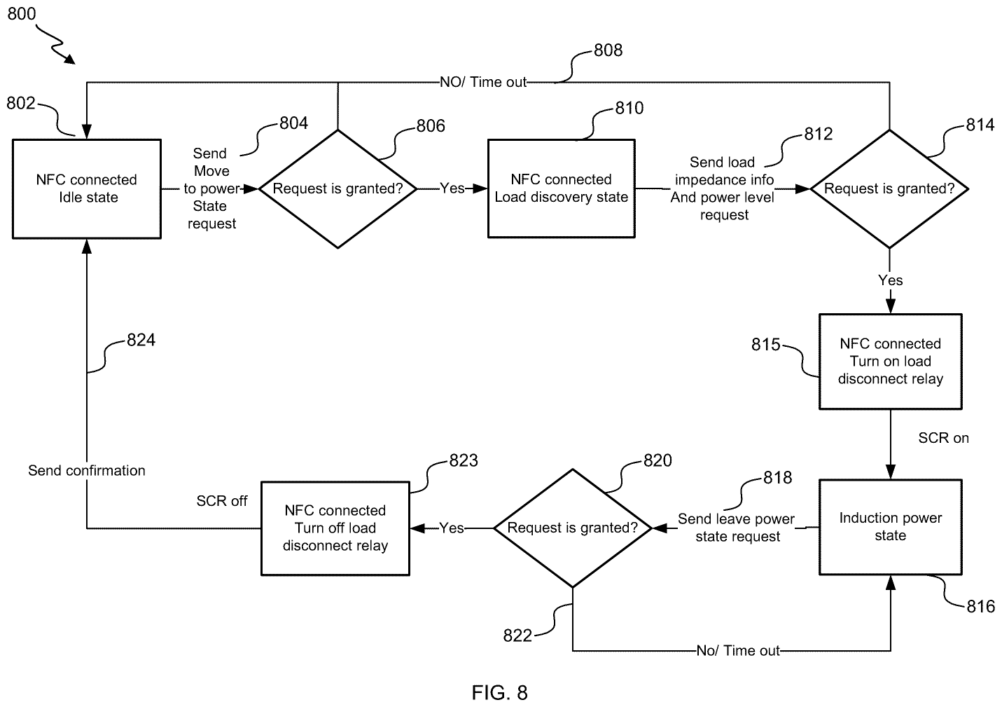

Referring to FIG. 8 a state diagram of an embodiment of the relay circuit 116 in the power circuit for the resonant power transmission in a control sequence. The power receiver turns the gate signal of the SCR 502 on and off during the power receiver and the power transmitter control sequence. At block 802, the NFC tag 214 of the power receiver is connected with the NFC reader 216 of the power transmitter. The power receiver is in an idle state implying the power transmission has not begun. The power receiver sends a request 804 to move to the power state.

At block 806, If the request is granted by the microcontroller unit 124 of the power receiver, the power receiver moves to the power state. If the microcontroller unit 124 of the power receiver doesn't allow the request or takes more than 100 milliseconds (ms) to respond, the power receiver goes back to the idle state. In case of time out of the request condition the power receiver moves back to an idle state too.

At block 810, the power receiver is initially connected at a lower frequency than the resonant frequency. This is a protection measure to ensure the smooth transition of power without damaging the circuit on both ends due to sudden increase of a surge current. The power transmitter that is in load 206 discovery states sends out request 812 for the information on load 206 impedance and power level to the power receiver.

At block 814, if the microcontroller unit 124 of the power receiver grants the request the SCR 502 is switched on by the microcontroller unit 124, at block 815. The SCR 502 signals the relay circuit 116 and the relay circuit 116 connects the load 206 of the power receiver to the resonant circuit 114. If request 812 is not granted or 20 ms are elapsed without response, the system illustrated in FIG. 2 returns back to the state at block 802.

At block 816, the load 206 of the power receiver is connected to the resonant circuit 114 and is being powered by the induction power from the power transmitter. If the user wishes to disconnect the power being supplied to the appliance, the power receiver sends out the request 818 to move to the connected state.

At block 820, if the microcontroller unit 124 of the power receiver grants the request 818 the SCR 502 is signaled by the microcontroller unit 124 to be switched off. In case more than 20 ms to respond, or rejection of the request 818, at 822, the system 100 moves back to an induction power state at block 816.

At block 823, the microcontroller unit 124 signals the latching circuit 110 to turn off the load disconnect relay in the relay circuit 116 and sends out a confirmation message to the power transmitter. In case of the SCR 502 embodiment, the SCR 502 will turn off when the current of a relay coil will drop below a holding current of SCR 502. The system 100 transitions to the idle state at block 802, at 824.

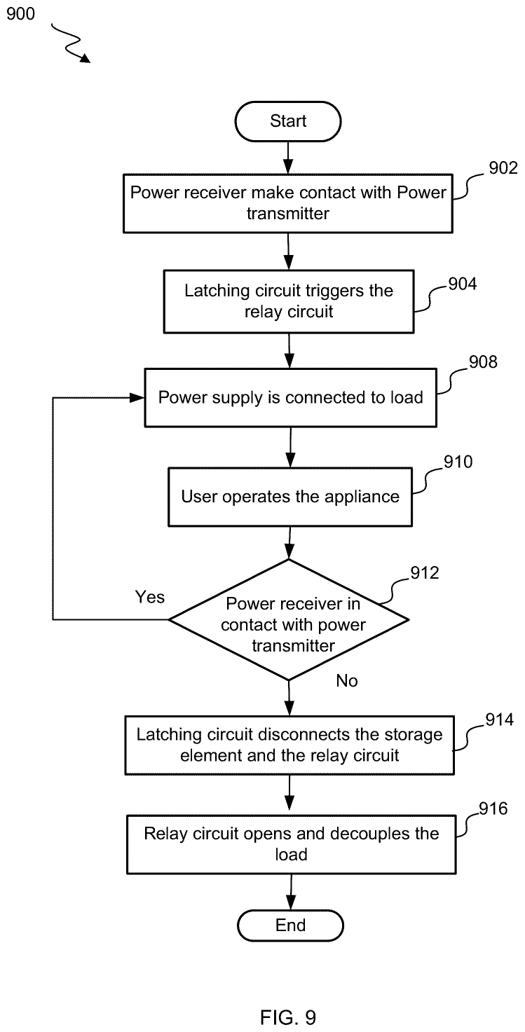

Referring to FIG. 9, a flow diagram of an embodiment of a system 100 in the power circuit for the resonant power transmission. At block 902, the power receiver in the appliance makes contact with the power transmitter. The electromagnetic flux from the coil of the power transmitter starts inducing current in the coil of the power receiver. The NFC circuit 102 follows the communication protocol of verifying the power transmitter. At block 904, the latching circuit connects the storage element 108 to the relay coil in the relay circuit 116 and the switch closes connecting the resonant circuit 114 to the load 206.

At block 908, the load 206 is powered by the current induced in the power-coil 112 that is also referred to as the power supply. The power receiver moves to the powered state. At block 910, a user operates the appliance since the appliance is now being powered by the power transmitter.

At block 912, if the power receiver is in contact with the power transmitter the power supply will remain connected to the load 206. If otherwise the power receiver begins a sequence for the decoupling of the load 206. The phrase “power receiver in contact with power transmitter” refers to any condition that inhibits the communication between the power receiver and the power transmitter. For instance, the user can just move the appliance away from the power transmitter, this will block the communication. In the case of turning off the power supply of the appliance or the power transmitter, communication is also inhibited.

At block 914, the power receivers transition from the power state to the connected state. In this phase the current from the storage element 108 gradually dissipates. In the case of SCR 502 when the current of the relay circuit 116 falls below the holding current the SCR 502, the latching circuit 110 is turned off. At block 916, the switch in the relay circuit 116 opens and decouples the load 206.

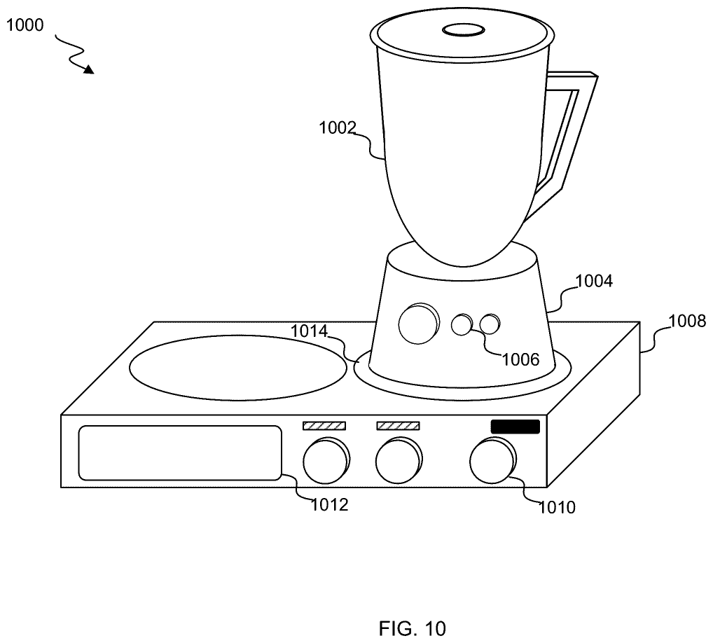

Referring to FIG. 10, a diagram of an embodiment of the resonant power transmission from the power transmitter to the appliance 1002. Appliance 1002 can be any electric device designed to perform a specific task, for instance, a blender. The appliance 1002 contains a housing base 1004 and control switches 1006. The housing base 1004 contains circuitry of the appliance 1002 including the power circuit for the resonant power transmission. The control switches 1006 are part of the user interface 212, to allow the user to operate the appliance 1002. The cooktop 1008 contains a regulating switch 1010, a LED display 1012 and a cooktop surface 1014. The regulating switches 1010 provide temperature and power control. The LED display 1012 indicates information like the type of a power mode, time, temperature, etc. The cooktop surface provides a guide to place the housing base 1004, to ensure coils in the power receiver and the power transmitter are in a vicinity of each other. When the housing base 1004 is placed on the cooktop 1008 and power is switched on, the power is induced in the appliance through the resonant power transmission.

Specific details are given in the above description to provide a thorough understanding of the embodiments. However, it is understood that the embodiments may be practiced without these specific details. For example, components may be shown in block diagrams in order not to obscure the embodiments in unrequired detail. In other instances, well-known circuits, processes, algorithms, structures, and techniques may be shown without unrequired detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

In the embodiments described above, for the purposes of illustration, processes may have been described in a particular order. It may be appreciated that in alternate embodiments, the methods may be performed in a different order than that described. It may also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data. These machine-readable instructions may be stored on one or more machine-readable mediums, such as compact disc read-only memory (CD-ROMs) or other type of optical disks, solid-state drives, tape cartridges, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the required tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to some configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, the technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate when discussing the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate when discussing the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made by way of example and not as limitation on the scope of the disclosure.

We claim:

1. A power circuit with near field communication (NFC) using resonant power transmission to power an appliance, the power circuit comprising:
a relay to selectively couple or decouple a load for the appliance;
an NFC circuit comprises a data communication circuit for receiving data;
a power supply harvesting the resonant power transmission to the appliance;
a latching circuit that controls the relay to couple the power supply to the load when the data communication circuit detects wireless communication to the appliance, wherein:
the latching circuit decouples the power supply to the load if the appliance is disconnected,
the decoupling is delayed after disconnection, and
the delay is enabled with power from the NFC circuit.

2. The power circuit with NFC using resonant power transmission to power the appliance of claim 1, wherein the relay decouples the load if the appliance does not follow a communication protocol.

3. The power circuit with NFC using resonant power transmission to power the appliance of claim 1, wherein the delay is caused by a capacitor that charged through a resistor from a power harvested from the NFC circuit.

4. The power circuit with NFC using resonant power transmission to power the appliance of claim 1, a power regulator provides lower voltage than the power supply wherein a resistor at an input of the power regulator discharges capacitance.

5. The power circuit with NFC using resonant power transmission to power the appliance of claim 1, wherein the delay is caused by a storage element that holds closed the relay during a transition from a powered state to a connected state.

6. The power circuit with NFC using resonant power transmission to power the appliance of claim 1, wherein the latching circuit can be an SCR switch controlled by a microcontroller unit.

7. The power circuit with NFC using resonant power transmission to power the appliance of claim 1, wherein the latching circuit can be an S-R latch constructed from a plurality of complementary metal-oxide semiconductor (CMOS) gates and a small signal transistor.

8. A method for power delivery using resonant power transmission to power an appliance utilizing near field communication (NFC), the method comprising:
selectively decoupling a load for the appliance with a relay;
receiving data with a communication circuit in an NFC circuit;
detecting presence of a power transmitter;
in response to detecting a power transmitter, controlling the relay by a latching circuit and hold the relay close during the resonant power transmission, wherein decoupling is delayed as a function of a storage element; and
providing power by the storage element to the relay, wherein:
the power is harvested from a resonant power transmission to the appliance, and
the storage element is energized with power from the NFC circuit.

9. The method for power delivery using resonant power transmission to power the appliance utilizing NFC of claim 8, wherein the relay decouples the load if the appliance does not follow a communication protocol.

10. The method for power delivery using resonant power transmission to power the appliance utilizing NFC of claim 8, wherein the storage element is a capacitor charged through a resistor from a power harvested from the NFC circuit.

11. The method for power delivery using resonant power transmission to power the appliance utilizing NFC of claim 8, a power regulator provides lower voltage than the power wherein a bleeder element discharges the storage element with a plurality of resistors added at an input of the power regulator.

12. The method for power delivery using resonant power transmission to power the appliance utilizing NFC of claim 8, wherein the latching circuit can be an SCR switch controlled by a microcontroller unit.

13. The method for power delivery using resonant power transmission to power the appliance utilizing NFC of claim 8, wherein the latching circuit can be an S-R latch constructed from a plurality of complementary metal-oxide semiconductor (CMOS) gates and a small signal transistor.

14. The method for power delivery using resonant power transmission to power the appliance utilizing NFC of claim 8, the communication circuit transmits data including a load impedance and a power level of the appliance.

15. The method for power delivery using resonant power transmission to power the appliance utilizing NFC of claim 8, wherein the storage element that holds closed the relay during a transition of the appliance from a connected state to a powered state.

16. A power circuit with near field communication (NFC) using resonant power transmission to power an appliance, comprises:
a relay to selectively couple or decouple a load for the appliance;
an NFC circuit comprises a data communication circuit for receiving data;
a power supply harvesting the resonant power transmission to the appliance;
a latching circuit that controls the relay to couple the power supply to the load when the data communication circuit detects wireless communication to the appliance, wherein:
the latching circuit decouples the power supply to the load if the appliance is disconnected,
the decoupling is delayed as a function of a storage element and a bleeder element, and
the storage element is energized with power from the NFC circuit.

17. The power circuit with NFC using resonant power transmission to power the appliance of claim 16, wherein the relay decouples the load if the appliance does not follow a communication protocol.

18. The power circuit with NFC using resonant power transmission to power the appliance of claim 16, wherein the storage element is a capacitor that is energized through a resistor from a power harvested from the NFC circuit.

19. The power circuit with NFC using resonant power transmission to power the appliance of claim 16, a power regulator provides low voltage wherein the bleeder element is a plurality of resistors that is added at an input of the power regulator to discharge the storage element.

20. The power circuit with NFC using resonant power transmission to power the appliance of claim 16, wherein the storage element closes and holds the relay during a transition from a powered state to a connected state.
